(19) United States
(12) Patent Application Publication
(10) Pub. No.: US 2025/0192250 A1
(43) Pub. Date: Jun. 12, 2025

(54) DISCHARGE OF ENERGY FROM A DAMAGED BATTERY ASSEMBLY

(71) Applicant: GM Global Technology Operations LLC, Detroit, MI (US)

(72) Inventors: Ryan Patrick Hickey, Austin, TX (US); Galen E. Ressler, White Lake, MI (US); Michael G. Leffert, Howell, MI (US)

(21) Appl. No.: 18/532,285

(22) Filed: Dec. 7, 2023

(51) Int. Cl. H01M 10/44; H01M 10/54; H01M 50/673

(52) U.S. Cl. CPC H01M 10/441; H01M 10/44; H01M 50/673; H01M 2220/20

(57) ABSTRACT

A system for discharging a battery assembly includes a fluid conduit configured to direct a liquid to the battery assembly, the fluid conduit including a fluid outlet, and a mixing device configured to be connected in fluid communication with the fluid conduit and the battery assembly. The mixing device is configured to incorporate a material into the liquid as the liquid flows through the mixing device and before the liquid interacts with the battery assembly. Incorporation of the material increases a conductivity of the liquid so that the liquid causes electrical discharge of the battery assembly when the liquid interacts with the battery assembly.

### INTRODUCTION

The subject disclosure relates to batteries, and more particularly to discharging battery assemblies.

Vehicles, including gasoline and diesel power vehicles, as well as electric and hybrid electric vehicles, feature battery storage for purposes such as powering electric motors, electronics and other vehicle subsystems. In some cases, it is desirable to discharge energy from a vehicle battery system, such as instances where a battery assembly is damaged. For example, if a vehicle is in an accident, it is advisable to fully discharge the battery system to remove stranded energy and mitigate potential for overheating. If a charging port or other electrical connection is damaged, the ability to effectively discharge the battery system is compromised. Accordingly, it is desirable to provide a device or system that can provide improved discharging capabilities in conditions where normal electric discharging is unavailable.

### SUMMARY

In one exemplary embodiment, a system for discharging a battery assembly includes a fluid conduit configured to direct a liquid to the battery assembly, the fluid conduit including a fluid outlet, and a mixing device configured to be connected in fluid communication with the fluid conduit and the battery assembly. The mixing device is configured to incorporate a material into the liquid as the liquid flows through the mixing device and before the liquid interacts with the battery assembly. Incorporation of the material increases a conductivity of the liquid so that the liquid causes electrical discharge of the battery assembly when the liquid interacts with the battery assembly.

In addition to one or more of the features described herein, the material is an ionic material configured to provide a concentration of ions to increase the conductivity of the liquid.

In addition to one or more of the features described herein, the battery assembly is disposed in a vehicle.

In addition to one or more of the features described herein, the mixing device includes a mixing chamber configured to be connected to the fluid conduit, the mixing chamber enclosing the material.

In addition to one or more of the features described herein, the material is configured as a solid layer disposed on an interior surface of the mixing chamber, and the solid layer is exposed to the liquid as the liquid flows through the mixing chamber.

In addition to one or more of the features described herein, the material is a particulate that fills at least part of the mixing chamber.

In addition to one or more of the features described herein, the material is a concentrated fluid.

In addition to one or more of the features described herein, the mixing device is configured as an attachment to the fluid conduit.

In addition to one or more of the features described herein, the mixing device is configured to be connected to a fluid port, the fluid port in fluid communication with a fluid passageway extending from the fluid port to the battery assembly.

In another exemplary embodiment, a method for discharging a battery assembly includes acquiring a fluid conduit, the fluid conduit connected to a source of a liquid, the fluid conduit including a fluid outlet, and flowing the liquid through the fluid conduit to a mixing device connected in fluid communication with the fluid conduit and the battery assembly. The method also includes incorporating, by the mixing device, a material into the liquid as the liquid flows through the mixing device, where incorporating the material increases the conductivity of the liquid, and directing the liquid to interact with the battery assembly and cause electrical discharge of the battery assembly.

In addition to one or more of the features described herein, the material is an ionic material configured to provide a concentration of ions to increase the conductivity of the liquid.

In addition to one or more of the features described herein, the mixing device includes a mixing chamber connected to the fluid conduit, the mixing chamber enclosing the material.

In addition to one or more of the features described herein, the material is configured as a solid layer disposed on an interior surface of the mixing chamber, and the solid layer is exposed to the liquid as the liquid flows through the mixing chamber.

In addition to one or more of the features described herein, the material is a particulate that fills at least part of the mixing chamber.

In addition to one or more of the features described herein, the material is a concentrated fluid.

In addition to one or more of the features described herein, the mixing device is configured as an attachment to the fluid conduit.

In addition to one or more of the features described herein, the mixing device is connected to a fluid port, and the liquid is directed from the fluid port to the battery assembly by a fluid passageway extending from the fluid port to the battery assembly.

In yet another exemplary embodiment, a vehicle system includes a battery assembly including one or more battery cells disposed in a housing, a fluid passageway extending from the housing and configured to deliver a liquid into the housing, and a fluid port in fluid communication with the fluid passageway. The fluid port includes a mixing chamber that encloses a material configured to increase a conductivity of the liquid, the mixing chamber configured to incorporate the material into the liquid as the liquid flows through the mixing chamber into the fluid passageway and before the liquid interacts with the battery assembly, where incorporation of the material increases the conductivity of the liquid so that the liquid causes electrical discharge of the battery assembly. The material is configured as a solid layer of the material disposed at an internal surface of the housing, a solid material, and/or a liquid mixture.

In addition to one or more of the features described herein, the fluid port is configured to be connected to a fluid conduit, the fluid conduit configured to be connected to a source of the liquid.

In addition to one or more of the features described herein, the material is configured as one of: the solid layer, a particulate that fills at least part of the liquid chamber, and a concentrated fluid.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a top view of a motor vehicle, in accordance with an exemplary embodiment;

FIG. 2 depicts a system for discharging a battery assembly, in accordance with an exemplary embodiment;

FIG. 3 depicts components of a system that are part of, or attached to, a flood port of a vehicle, in accordance with an exemplary embodiment;

FIG. 4 depicts a system for discharging a battery assembly, in accordance with an exemplary embodiment; and

FIG. 5 is a flow diagram depicting aspects of a method of thermal management of a battery assembly, in accordance with an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with an exemplary embodiment, methods, devices and systems are provided for electrical discharge of a battery assembly or system, such as a battery pack in an electric or hybrid vehicle. The methods, devices and systems described herein may be applicable to situations or conditions where existing electrical connections are damaged or unavailable. For example, embodiments are applicable in situations where an electric or hybrid vehicle is damaged and the vehicle's normal electrical connections (e.g., charge port) are also damaged or inaccessible.

An embodiment of a discharging system includes a fluid conduit or other mechanism for delivering a liquid such as water to a battery assembly. The system also includes a device for increasing the electrical conductivity of the liquid prior to introduction of the liquid to battery cells. In an embodiment, the device is configured to introduce an ionic compound (e.g., salt) or other material that provides a concentration of ions to the water, or otherwise increases the conductivity. For example, a salt or other material may be included in a fluid port of a vehicle or an attachment to a hose or other conduit, such that at least some of the material dissolves in the liquid and increases the liquid conductivity.

Embodiments described herein present numerous advantages and technical effects. The embodiments provide effective methods of discharging energy from battery assemblies, particularly in situations in which other discharging options are unavailable.

The embodiments are not limited to use with any specific vehicle and may be applicable to various contexts. For example, embodiments may be used with automobiles, trucks, aircraft, construction equipment, farm equipment, automated factory equipment, medical devices, power supply systems and/or any other device or system that includes a battery assembly.

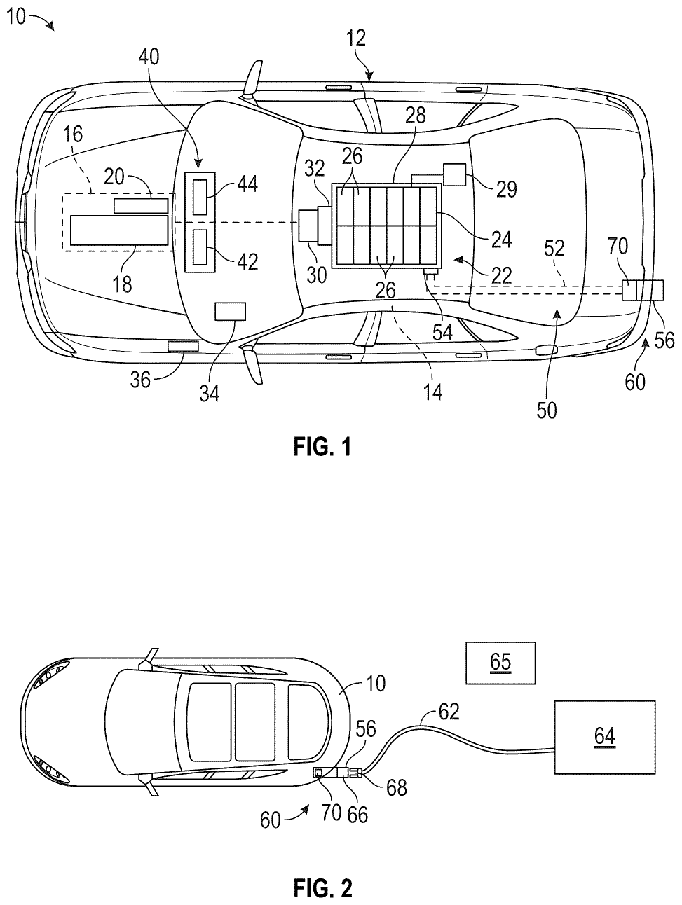

FIG. 1 shows an embodiment of a motor vehicle 10, which includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a braking subsystem, a suspension system, a steering subsystem, a fuel injection subsystem, an exhaust subsystem and others.

The vehicle 10 may be a combustion engine vehicle, an electrically powered vehicle (EV) or a hybrid vehicle. In an embodiment, the vehicle 10 is a hybrid vehicle that includes a combustion engine system 18 and at least one electric motor assembly. In an embodiment, the propulsion system 16 includes an electric motor 20, and may include one or more additional motors positioned at various locations. The vehicle 10 may be a fully electric vehicle having one or more electric motors.

The vehicle 10 includes a battery system 22, which may be electrically connected to the motor 20 and/or other components, such as vehicle electronics. The battery system 22 may be configured as a rechargeable energy storage system (RESS). In an embodiment, the battery system 22 includes a battery assembly such as a high voltage battery pack 24 having a plurality of battery modules 26. The battery pack 24 may be disposed in a housing 28. The battery system 22 may also include a monitoring unit 29 that includes components such as a processor, memory, an interface, a bus and/or other suitable components.

It is noted that a “battery assembly” may be a single battery cell or a group of cells. For example, the battery assembly may be the battery pack 24, a battery module 26 or an individual cell or group of cells in a module 26.

The battery system 22 is electrically connected to components of the propulsion system 16. The propulsion system 16 includes an inverter module 30, and may also include a direct current (DC)-DC converter module 32. The inverter module 30 (e.g., a traction power inverter unit or TPIM) converts direct current (DC) power from the battery system 22 to poly-phase alternating current (AC) power (e.g., three-phase, six-phase, etc.) to drive the motor 20.

Various control modules (electronic control modules or ECUs) may be included in the vehicle 10. For example, an on-board charging module (OBCM) 34 may be included, which electrically connects the battery system 22 to a charge port 36, and controls aspects of charging the battery system 22 (e.g., from a charging station or other vehicle) and/or providing charge to an external system (e.g., vehicle-vehicle charging).

The vehicle 10 also includes a computer system 40 that includes one or more processing devices 42 and a user interface 44. The various processing devices and units may communicate with one another via a communication device or system, such as a controller area network (CAN) or transmission control protocol (TCP) bus.

The vehicle 10 may include components or a system that facilitates exposure of the battery pack 24 to a fluid. The fluid may be water, a water-based solution, a foam and/or any other desired fluid or combination of fluids. Such components may be used for a variety of purposes, such as discharging the battery pack 24 as described herein, or fire suppression.

For example, the vehicle 10 includes a fluid injection system 50 having an internal fluid conduit, referred to herein as a fluid passageway 52. The fluid passageway 52 is connected at one end to an inlet 54 at the housing 28, which allows water or other fluid to flood the battery pack 24. The fluid passageway 52 may take various forms, such as tubing (e.g., plastic or rubber) or piping.

Another end of the fluid passageway 52 terminates at a flood port 56. The flood port 56 is disposed proximate to an exterior of the vehicle (e.g., at or near the rear bumper or trunk) and provides a connection to an external source of fluid. The flood port 56 may be disposed at any suitable location, and thus is not limited to the location shown in FIG. 1.

Embodiments include a device or mechanism for applying a liquid to a battery assembly in order to facilitate discharging the battery assembly. The device or mechanism is provided to incorporate a material into the liquid (e.g., water), in order to increase the conductivity of the liquid, such that a conductive pathway is provided for discharging any energy retained in the battery assembly.

The material is dissolved, mixed or otherwise combined with the fluid so that the fluid provides a conductive path for the battery assembly to discharge energy. For example, the conductive path causes current to flow from positive to negative poles of cells and/or modules 26 in the battery pack. The conductive path may be grounded or electrically isolated.

The material may be an ionic material, which provides a concentration of ions that provides conductivity, and provides an electrical pathway with a resistance that is selected to allow for discharging at a desired rate. The material may be any suitable material that provides a conductive path, such as a salt, an acid, conductive nanoparticles and others.

FIGS. 1 and 2 depict aspects of an embodiment of a discharging system 60, which is configured provide a fluid, such as water or other suitable liquid, to facilitate discharging a battery assembly, such as the battery pack 24. In an embodiment, as shown in FIGS. 1 and 2, the discharging system includes a mixing chamber 70 for combining a material with a liquid to increase the conductivity of the liquid and facilitate discharging.

Referring to FIG. 2, in an embodiment, the discharging system 60 includes, or is connectable to, a fluid conduit 62, such as a hose. The fluid conduit 62 is connected to a fluid source 64, which in an embodiment, is water, a water-based liquid or other suitable liquid. The fluid source 64 may be a tank, fire hydrant, emergency response vehicle, water truck or other source.

The discharging system 60 may include components of the fluid injection system 50. For example, the flood port 56 includes a conduit fitting 66 configured to engage an outlet 68 of the fluid conduit 62.

The discharging system 60 includes a mixing device having a mixing chamber 70. The mixing chamber 70 encloses or houses a material that, when mixed or combined with the liquid, increases the conductivity of the liquid. For example, the mixing chamber houses a salt (e.g., sodium chloride), an acid or other material that is configured to dissolve in, or otherwise combine with, the liquid to provide a concentration of ions. The concentration may be selected to provide a desired resistivity to the liquid.

In an embodiment, the mixing chamber 70 is included in, or fluidly connected to, the flood port 56. For example, the mixing chamber 70 can be included in the flood port, or disposed between the flood port 56 and the fluid passageway 52. In another example, the mixing chamber 70 may be formed in a separate component that can be attached to the flood port 56 (e.g., similar to an adapter).

In an embodiment, aspects of discharging the battery pack 24 may be performed by a human operator exclusively, performed by a processing device or system, or both. For example, a controller 65 may be provided to control aspects of connecting the fluid conduit 62 (e.g., by controlling an actuator to engage the flood port 56) and/or controlling fluid flow (e.g., controlling a pump).

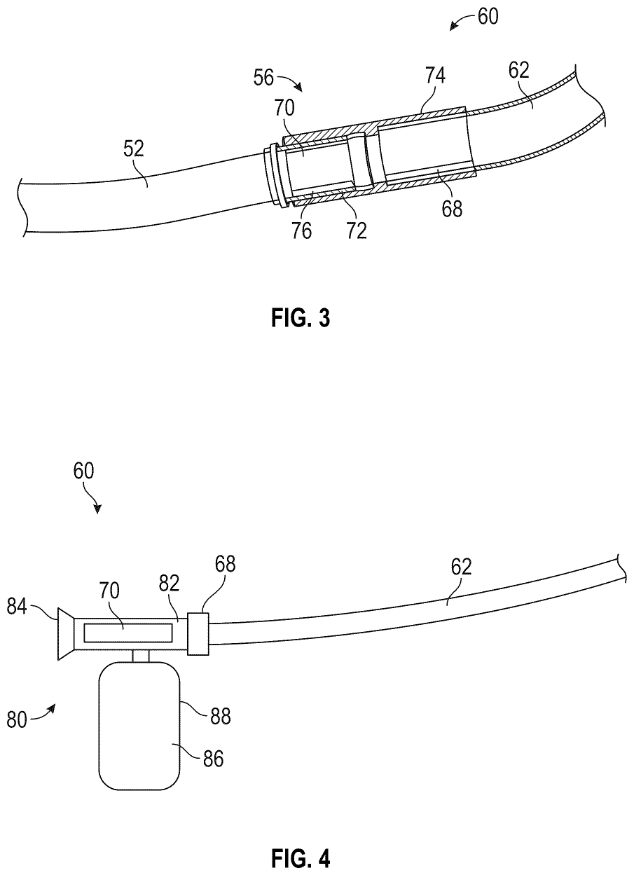

FIG. 3 shows an example in which the mixing chamber 70 is part of the flood port 56, and also shows an example of a configuration of the material used to increase conductivity of a liquid.

In this example, the mixing chamber 70 is formed within a fitting 72. The fitting 72 is coupled to the fluid passageway 52, and is configured to engage the outlet 68 of the fluid conduit 62. The flood port 60 may include various components, such as sealing features, and a locking mechanism such as a sliding sleeve 74.

The mixing chamber houses or contains a material 76 configured to increase the conductivity of water (or other desired liquid) as the water flows through the mixing chamber 70 and into the fluid passageway 52. For example, as shown in FIG. 3, the material 76 is formed as a solid layer or film. As water flows through the mixing chamber 70, some of the material dissolves or otherwise combines with the water to increase the conductivity. The thickness of the layer may be selected based on various criteria, such as a desired concentration of ions (or conductive particles), flow rate of the water, a number of expected uses, and others.

In an embodiment, the mixing chamber 70 is incorporated into, or configured as an attachment to, the outlet 68 of the fluid conduit. FIG. 4 depicts an example of the system 60 including a mixing assembly 80 that is attached to the outlet 68. The mixing assembly 80 may be a removeable attachment or fixed to the outlet 68.

The mixing chamber 70 is formed in a flow component 82 in fluid communication with the outlet 68 and a nozzle 84. In this example, the material is dissolved in a concentrated fluid mixture or ionic solution 86 in a container 88 attached to the flow component 82.

Whether incorporated as part of the flood port 56, as part of the outlet 68 or as an attachment, the mixing chamber 70 may include the material in any of various forms. Such forms may include a layer or solution as discussed above, or other forms, such as a powder or particulate, dissolvable solid structures (e.g., beads, a mesh, a screen, etc.) or any other suitable form.

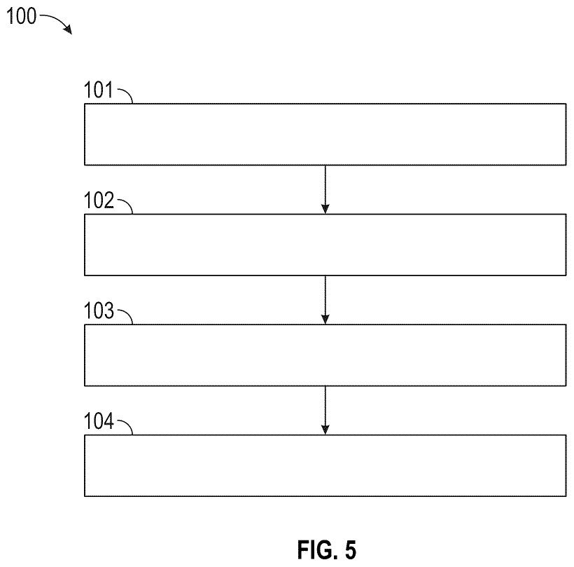

FIG. 5 illustrates embodiments of a method 100 of discharging a battery assembly. The method 100 (or parts thereof) may be performed manually by a human operator (e.g., owner, emergency responder, technician, etc.) and/or by any suitable processing device or devices.

The method 100 includes a number of steps or stages represented by blocks 101-104. The method 100 is not limited to the number or order of steps therein, as some steps represented by blocks 101-104 may be performed in a different order than that described below, or fewer than all of the steps may be performed.

The method 100 is discussed in conjunction with the vehicle 10 and the discharging system 60 of FIG. 3 or 4, for illustration purposes. The method 100 is not so limited, as the method 100 can be applied to any device or system that utilizes battery storage (e.g., electrical equipment, various vehicles, manufacturing equipment, etc.). In addition, the method 100 may be performed using any suitable mechanism that allows for combining a liquid with a material for enhancing conductivity, and applying the resulting liquid mixture or solution to a battery assembly. In addition, although the method 100 is discussed in conjunction with water as the liquid to be applied to a battery assembly, any suitable liquid may be used.

The method 100 may be performed by various persons or systems. For example, the method 100 can be performed by first responders or second responders to remove stranded energy from a battery damaged due to an accident or vehicle breakdown. Other applications for the method 100 may include discharging prior to salvage of a vehicle or other equipment.

At block 101, a supply of water is acquired. For example, a conduit, such as the fluid conduit 62 (e.g., a hose), is connected to a water source. The water source may be any suitable source, such as a tank, a municipal hydrant, an emergency response vehicle (e.g., water truck) or others.

At block 102, the fluid conduit 62 is operated to flow water toward a battery assembly, such as a battery pack in an electric vehicle, electrical equipment or other electrical device or system. For example, water is flowed to the battery pack 24 (e.g., via the flood port 56 if available, or by spraying with the nozzle 84).

At block 103, the ionic compound is combined with the water as the water flows through the attachment, the nozzle or the flood port. As a result, the water forms an ionic solution with an increased conductivity.

For example, if the vehicle includes the flood port 56, water is combined with the material as contained within the flood port 56 (or in an attachment or component attached to the flood port). If the vehicle 10 does not include a flood port, a hose with an attachment that includes an ionic compound (or other suitable material), or a nozzle that includes the material, is used to flood the battery pack 24.

At block 104, stranded energy in the battery pack 24 discharges. The discharge is facilitated by conductive pathways provided by the combine liquid having an increased conductivity. For example, the ionic solution causes current to flow from positive to negative poles of cells and/or modules within the battery pack 24. Energy in the form of heat (and potentially steam or vapor) is produced and exits the battery pack 24.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A system for discharging a battery assembly, the system comprising:
a fluid conduit configured to direct a liquid to the battery assembly, the fluid conduit including a fluid outlet;
a mixing device configured to be connected in fluid communication with the fluid conduit and the battery assembly, the mixing device configured to incorporate a material into the liquid as the liquid flows through the mixing device and before the liquid interacts with the battery assembly, wherein incorporation of the material increases a conductivity of the liquid so that the liquid causes electrical discharge of the battery assembly when the liquid interacts with the battery assembly.

2. The system of claim 1, wherein the material is an ionic material configured to provide a concentration of ions to increase the conductivity of the liquid.

3. The system of claim 1, wherein the battery assembly is disposed in a vehicle.

4. The system of claim 1, wherein the mixing device includes a mixing chamber configured to be connected to the fluid conduit, the mixing chamber enclosing the material.

5. The system of claim 4, wherein the material is configured as a solid layer disposed on an interior surface of the mixing chamber, and the solid layer is exposed to the liquid as the liquid flows through the mixing chamber.

6. The system of claim 4, wherein the material is a particulate that fills at least part of the mixing chamber.

7. The system of claim 4, wherein the material is a concentrated fluid.

8. The system of claim 1, wherein the mixing device is configured as an attachment to the fluid conduit.

9. The system of claim 1, wherein the mixing device is configured to be connected to a fluid port, the fluid port in fluid communication with a fluid passageway extending from the fluid port to the battery assembly.

10. A method for discharging a battery assembly, the method comprising:
acquiring a fluid conduit, the fluid conduit connected to a source of a liquid, the fluid conduit including a fluid outlet;
flowing the liquid through the fluid conduit to a mixing device connected in fluid communication with the fluid conduit and the battery assembly;
incorporating, by the mixing device, a material into the liquid as the liquid flows through the mixing device, wherein incorporating the material increases the conductivity of the liquid; and
directing the liquid to interact with the battery assembly and cause electrical discharge of the battery assembly.

11. The method of claim 10, wherein the material is an ionic material configured to provide a concentration of ions to increase the conductivity of the liquid.

12. The method of claim 10, wherein the mixing device includes a mixing chamber connected to the fluid conduit, the mixing chamber enclosing the material.

13. The method of claim 12, wherein the material is configured as a solid layer disposed on an interior surface of the mixing chamber, and the solid layer is exposed to the liquid as the liquid flows through the mixing chamber.

14. The method of claim 12, wherein the material is a particulate that fills at least part of the mixing chamber.

15. The method of claim 12, wherein the material is a concentrated fluid.

16. The method of claim 10, wherein the mixing device is configured as an attachment to the fluid conduit.

17. The method of claim 10, wherein the mixing device is connected to a fluid port, and the liquid is directed from the fluid port to the battery assembly by a fluid passageway extending from the fluid port to the battery assembly.

18. A vehicle system comprising:
a battery assembly including one or more battery cells disposed in a housing;
a fluid passageway extending from the housing and configured to deliver a liquid into the housing; and
a fluid port in fluid communication with the fluid passageway, the fluid port including a mixing chamber that encloses a material configured to increase a conductivity of the liquid, the mixing chamber configured to incorporate the material into the liquid as the liquid flows through the mixing chamber into the fluid passageway and before the liquid interacts with the battery assembly, wherein incorporation of the material increases the conductivity of the liquid so that the liquid causes electrical discharge of the battery assembly, the material configured as at least one of: a solid layer of the material disposed at an internal surface of the housing, a solid material, and a liquid mixture.

19. The vehicle system of claim 18, wherein the fluid port is configured to be connected to a fluid conduit, the fluid conduit configured to be connected to a source of the liquid.

20. The vehicle system of claim 18, wherein the material is configured as one of: the solid layer, a particulate that fills at least part of the mixing chamber, and a concentrated fluid.
